(19) United States
(12) Patent Application Publication
(10) Pub. No.: US 2007/0060400 A1
(43) Pub. Date: Mar. 15, 2007

(54) Torsion vibration damping device

(76) Inventor: Vladimir Kobelev, Attendorn (DE)

Correspondence Address: Wyatt, Gerber & O'Rourke, LLP, 99 Park Avenue, New York, NY, 10016, US

(21) Appl. No.: 11/501,503

(22) Filed: Aug. 8, 2006

(30) Foreign Application Priority Data
Aug. 9, 2005 (DE) 102005037996.6-27

(51) Int. Cl. F16F 15/12; F16D 3/10

(52) U.S. Cl. 464/160; 192/207

(57) ABSTRACT

A decoupling device for a driving disc which, for torque transmitting purposes, is connected to a driveshaft via a torsion spring, wherein the end of the driveshaft is provided in the form of a hollow shaft, wherein the torsion spring is bar-shaped and by means of one end is secured in a rotationally fast way in the driveshaft and by means of the other end is secured at the driving disc, and wherein a bearing sleeve is freely rotatably supported relative to the free end of the hollow shaft is firmly connected to the driving disc.

### FIELD OF THE INVENTION

The invention relates to a torsion vibration damping device, also called a decoupling device, for a driving disc which, for torque transmitting purposes, is connected to a driveshaft via spring and damping elements. Force can be applied from the driving disc to the driveshaft or from the driveshaft to the driving disc. Suitable driveshafts can be crankshafts or camshafts or internal combustion engines for example, with subsidiary drives being driven by means of the driving disc. Because of the periodic mode of operation of devices such as internal combustion engines, or of piston compressors for example, the shaft ends of such devices are subject to irregularities in respect of angular speed and torque, which can be amplified by vibration and resonance symptoms of the shafts.

### BACKGROUND OF THE INVENTION

In order to dampen drive irregularities affecting the subsidiary drives, devices incorporate spring and damping elements made of elastomer into driving discs, wherein the spring and damping elements combine a damping and spring effect in one component.

Elastomer as the material of the spring and damping elements comprises a number of disadvantages. The stiffness and thus the natural frequency of the element depend on the ambient temperature, which can adversely affect the damping effect. In addition, the material of the elements is subject to an aging process. The material hardens with time, which can result in a further adverse effect on damping.

Furthermore, elastomer materials are susceptible to environmental influences, which include aggressive liquids, oils, and gases which are present in internal combustion engines. Another disadvantage is that the damping properties depend on the elastomer and can be varied only to a limited extent. The spring and damping elements made of elastomer require a relatively large amount of space.

### OBJECT OF THE INVENTION

It is an object of the present invention to provide a decoupling device for an assembly consisting of a driving disc and a driveshaft, which decoupling device is of a compact design and comprises continuously good and freely selectable spring and damping properties.

### SUMMARY OF THE INVENTION

Accordingly, the invention provides a decoupling device for a driving disc which, for torque transmitting purposes, is connected to a driveshaft via a torsion spring. The end of the driveshaft is provided in the form of a hollow shaft. The torsion spring is bar-shaped and is secured at one end to the driveshaft first by securing means in a rotationally fast way, and at the other end secured to the driving discs by second securing means. A bearing sleeve is also provided which is rotationally supported relative to the free end of the hollow shaft and is firmly connected to the driving disc.

By using a bar-shaped torsion spring inside a hollow shaft, it is possible to achieve a very compact design which combines the effect of the spring and of the damping device in one component. The torsion spring made of metal guarantees a long service life independently of temperature and other influences. The number of components is small and the assembly is thus cost-effective. In addition, the material of the spring and damping unit ensures a high damping efficiency and a high degree of heat dissipation.

In a preferred embodiment, the torsion spring can consist of a bundle of individual bars, more particularly of hexagonal bars. The torsion of the spring causes a relative sliding movement between the individual bars in the bundle of bars, so that the damping effect is increased.

Alternatively, it is possible for the torsion spring to be provided in the form of a solid part, such as a solid bar or a hollow bar. Furthermore, the device can be provided with a central portion with a round cross-section and polygonal end portions. The damping effect in this case takes place in the form of internal damping in the bar portion.

In the above-mentioned embodiments, the spring is preferably form-fittingly secured in the direction of the rotation in the driveshaft, on the one hand, and in the driving disc, on the other hand.

In another embodiment, a bearing sleeve which supportingly cooperates with the bearing sleeve of the driving disc is secured on the driveshaft, such as at the region of the hollow shaft, and thus any bending forces may be accommodated under conditions of free rotatability. It is possible to provide a bearing portion of the bearing sleeve which surrounds the outside of an inner bearing sleeve of the driving disc. In a further alternative, it is possible to provide a bearing portion of the bearing sleeve positioned inside the outer bearing sleeve of the driving disc.

In further embodiments, additional bearing means, such as a friction bearing bush between the bearing sleeve on the driveshaft and the bearing sleeve at the driving disc can be provided. A needle bearing may also be used. It is a matter of choice at which of the two bearing sleeves the bearing means are fixed. Between the bearing sleeve and the driving disc, an axial securing means can be provided which ensures relative rotability between the two parts and ensures that the driving disc on the bearing sleeve cannot be lost. Such axial securing means can be provided in the form of overlapping collars, retaining rings or similar such devices.

The bearing sleeve on the driveshaft can be threaded on to a fixing portion in the region of the hollow shaft of the driveshaft. Fixing via a press fit is also possible.

### BRIEF DESCRIPTION OF THE DRAWINGS

Preferred embodiments of the invention are illustrated in the drawings and will be described below.

FIG. 1 illustrates a torsion vibration damping device, according to the invention, having a partial cross-section.

FIG. 2 illustrates the torsion vibration damping device, according to FIG. 1, in an exploded view.

FIG. 3 illustrates the details of the torsion vibration damping device according to FIGS. 1 and 2.

FIG. 4 illustrates a torsion vibration damping device, according to the invention, having a partial cross-section.

FIG. 5 illustrates the torsion vibration damping in an exploded view.

FIG. 6 illustrates the details of the torsion vibration damping device according to FIGS. 4 and 5.

FIG. 7 illustrates a torsion vibration damping device, according to the invention, having a partial cross-section.

FIG. 8 illustrates the torsion vibration damping device according to FIG. 7 in an exploded view.

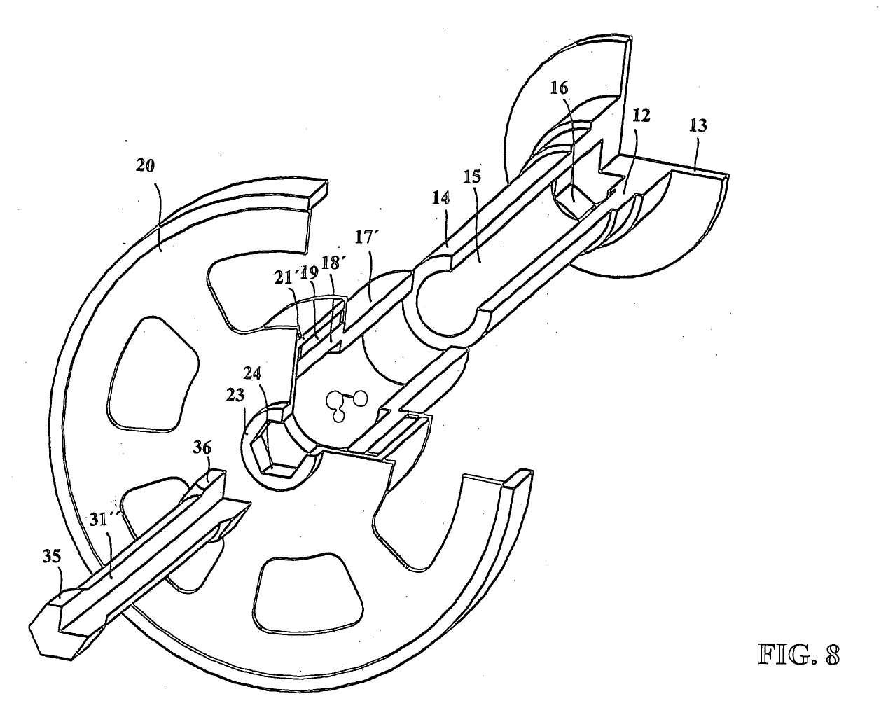

FIG. 9 illustrates the details of the torsion vibration damping device according to FIGS. 7 and 8.

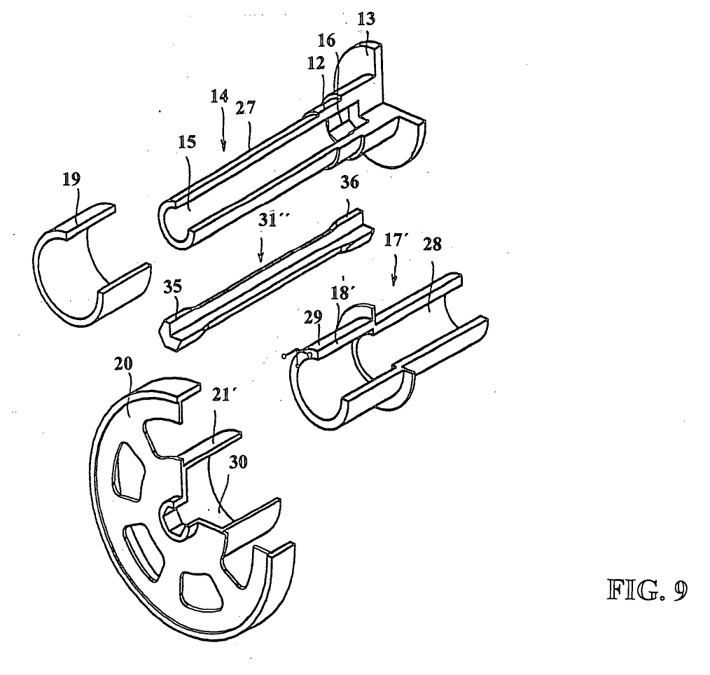

FIG. 10 illustrates a torsion vibration damping device, according to the invention, having a partial cross-section.

FIG. 11 illustrates the torsion vibration damping in an exploded view.

FIG. 12 illustrates the details of the torsion vibration damping device according to FIGS. 10 and 11.

### DETAILED DESCRIPTION

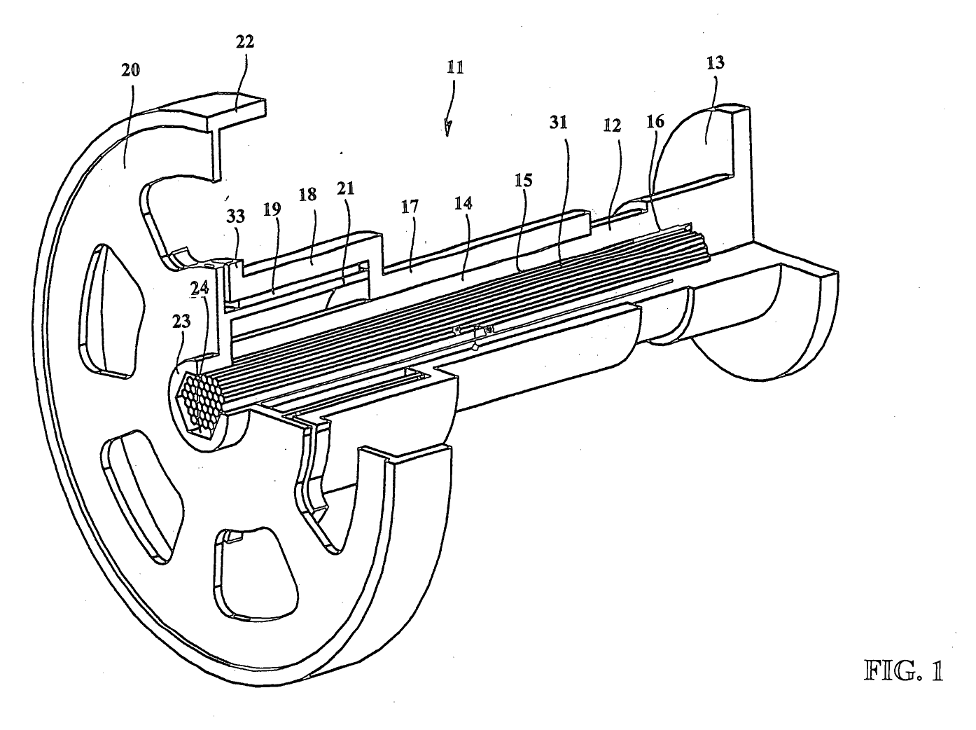

In all the illustrations, the parts are shown with broken-out sectors of a circumferential angle of approximately 90°. FIG. 1 illustrates an inventive torsion vibration damping device 11 which is connected to the end of a driveshaft 13. The driveshaft 13 is shown in the form of a flange-like widened diameter which is in fact produced so as to be integral with the driveshaft, for example a crankshaft. The free end of the driveshaft 13 is in the form of a hollow shaft 12, and at the inner end of an inner hollow chamber 15, there are arranged form-fitting means 16 provided in the form of a hexagon socket. A bearing sleeve 17 is threaded in a rotationally fast way onto a fixing portion 14 of the driveshaft 13, with the thread pitch relative to the direction of rotation of the driveshaft 13 having been selected to be such that the thread is tightened in operation. The bearing sleeve 17 could also be secured on the fixing portion 14 by means of a press fit or in any other suitable way. A widened bearing portion 18 of the bearing sleeve 17 accommodates a friction bearing bush 19 in which there is rotatably supported a driving disc 20 by means of an attached bearing sleeve 21. The bearing portion 18 is delimited by a flange 33 next to the driving disc. The bearing portion 18 and the driving disc 20 can be axially secured relative to one another by means not shown in greater detail. At the outer gear of the driving disc 20 it is possible to identify a belt crown 22 for a flat belt. Instead of same, it is also possible to provide a belt crown for a V-belt, a toothed belt or a chain gear. Furthermore, the driving disc 20 comprises a hub 23 with form-fitting means 24 in the form of a hexagon socket. Into the hollow shaft 12, there is slid a torsion spring 31 which consists of a plurality of individual hexagon bars and which, in its entirety, by means of a front end 35, engages the form-fitting means 16 at the inner end of the hollow chamber 15 of the hollow shaft 12 on the one hand and, by means of a rear end 36, the form-fitting means 24 of the driving disc 20 on the other hand. As a result, the driving disc 20 is rotatably supported in a low-friction way relative to the bearing sleeve 17 and, on the other hand, it is rotatable relative to the end of the hollow shaft 12 only when the torsion spring 31 is rotated for vibration damping purposes. When the torsion spring 31 is rotated, damping occurs as a result of the relative surface friction of the individual hexagonal bars inside the bar bundle, so that the elastic movement of the driving disc 20 relative to the driveshaft 13 is dampened.

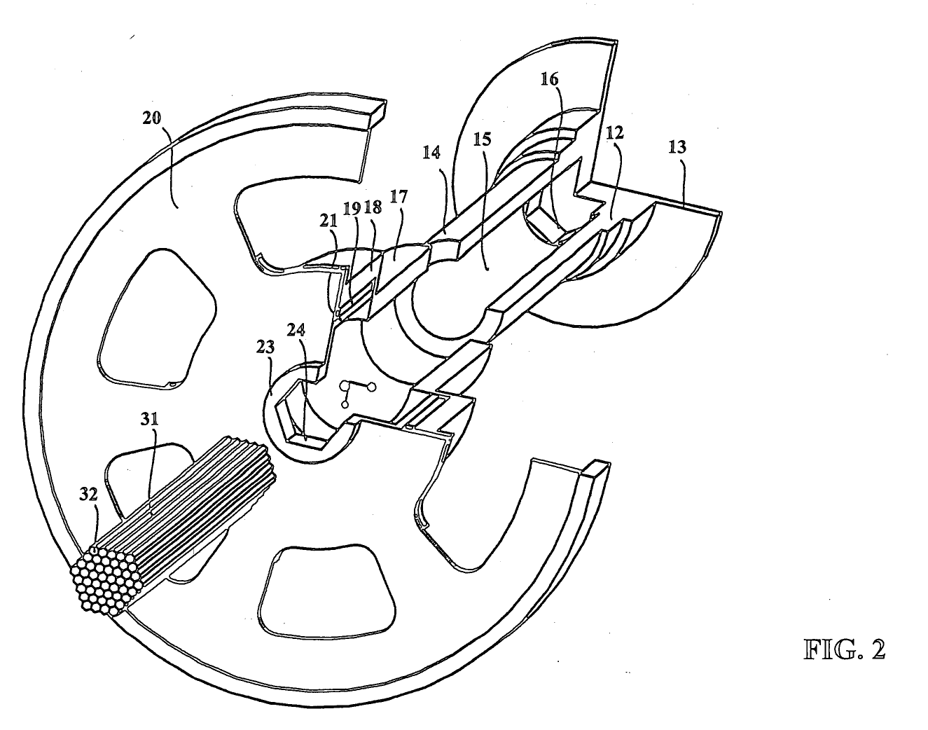

Any details in FIG. 2 which are identical to those shown in FIG. 1 have been given the same reference numbers, and it is particularly obvious that the form-fitting means 16 at the inner end of the hollow chamber 15 and the form-fitting means 24 in the hub 23 of the driving disc 20 are provided in the form of hexagon sockets, whereas the torsion spring 31 consisting of individual hexagonal bars 32, as a whole, has the configuration of a hexagon. As indicated in this figure, it is possible to pre-assemble the bearing sleeve 17 with the bearing sleeve 19 and the driving disc 20 with the bearing sleeve 21, while being axially secured relative to one another. The bearing sleeve 17 is then threaded onto the fixing portion 14 of the hollow shaft 12 and finally, the bar bundle consisting of individual hexagonal bars 32 of the torsion spring 31 is axially slid into the assembly until the ends enter a form-fitting and positive connection with the form-fitting means 16 and the form-fitting means 24, and are axially secured.

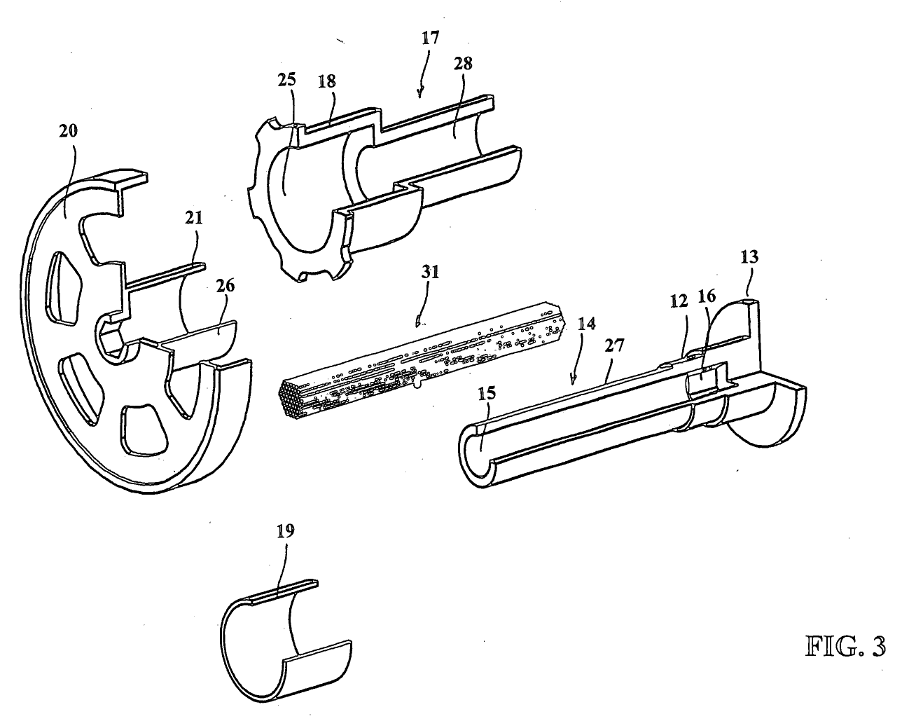

Any details in FIG. 3 which are identical to those shown in the preceding figures have been given the same reference numbers. The inner bearing face 25 is additionally referred to at the bearing portion 18 of the bearing sleeve 17 and the outer bearing face 26 is additionally referred to at the bearing sleeve 21 of the driving disc 20. Between the two, there is positioned the friction bearing bush 19. Instead of the latter, it is possible to use a needle bearing. Furthermore, it is possible to see the outer thread 27 on the fixing portion 14 of the hollow shaft 12 and the inner thread 28 in the bearing sleeve 27 in their respective positions.

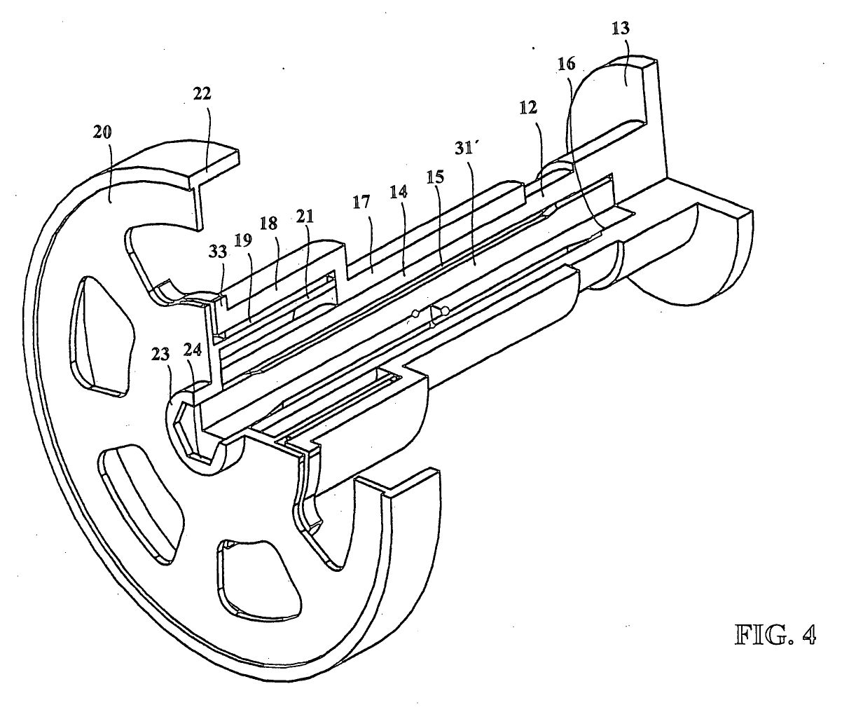

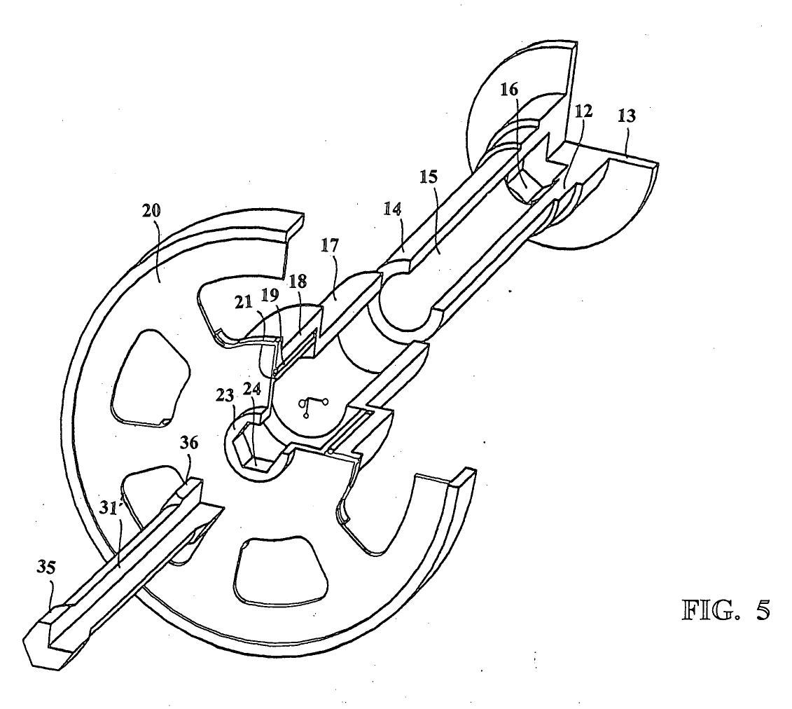

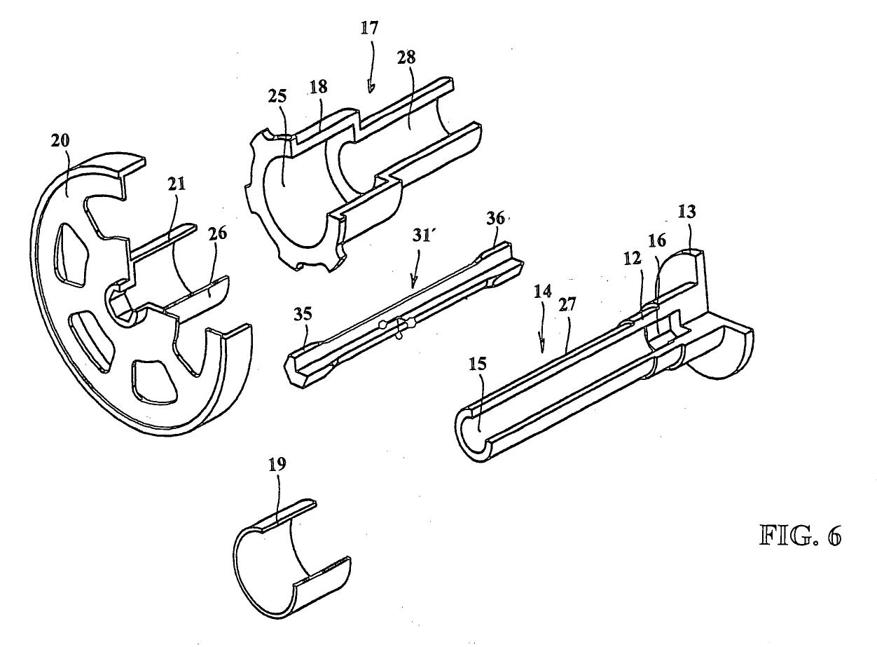

FIGS. 4, 5 and 6 show a second embodiment of a torsion vibration damping device, according to the invention and correspond to FIGS. 1, 2 and 3. Identical details in FIGS. 1, 2 and 3 have been given the same reference numbers, whereas any details which were merely modified have been given a single index “′”. The torsion spring 31′ deviates from the first embodiment in that it is provided as a solid bar. The damping forces are generated as a result of internal material damping during torsion. The torsion spring 31′ comprises hexagonal end portions 35, 36 and its central region is in the form of a round solid bar.

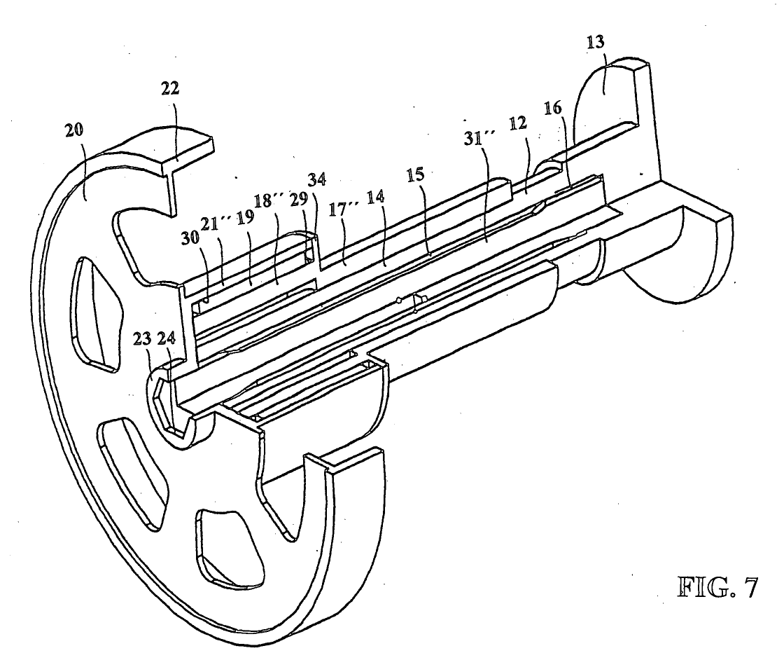

FIG. 7, 8 and 9 show a third embodiment of a torsion vibration damping device largely correspond to FIGS. 4, 5 and 6 to the description of which reference is hereby made and thus also to the description of FIGS. 1, 2 and 3. Any details which were merely modified have been provided with a double index “″”. The third embodiment deviates from the first and second embodiments in that, in this case, the bearing portion 18″ of the bearing sleeve 17″ is positioned opposite the outer bearing sleeve 21″ at the driving disc 20″. The bearing portion 18″ thus forms an outer bearing face 29 and the bearing sleeve 21″ an inner bearing face 20. The bearing portion 18″ is delimited by a flange 34 at the driveshaft end. Between the two bearing faces 29, 30 there is positioned the friction bearing bush 19″. The latter could be replaced by a needle bearing.

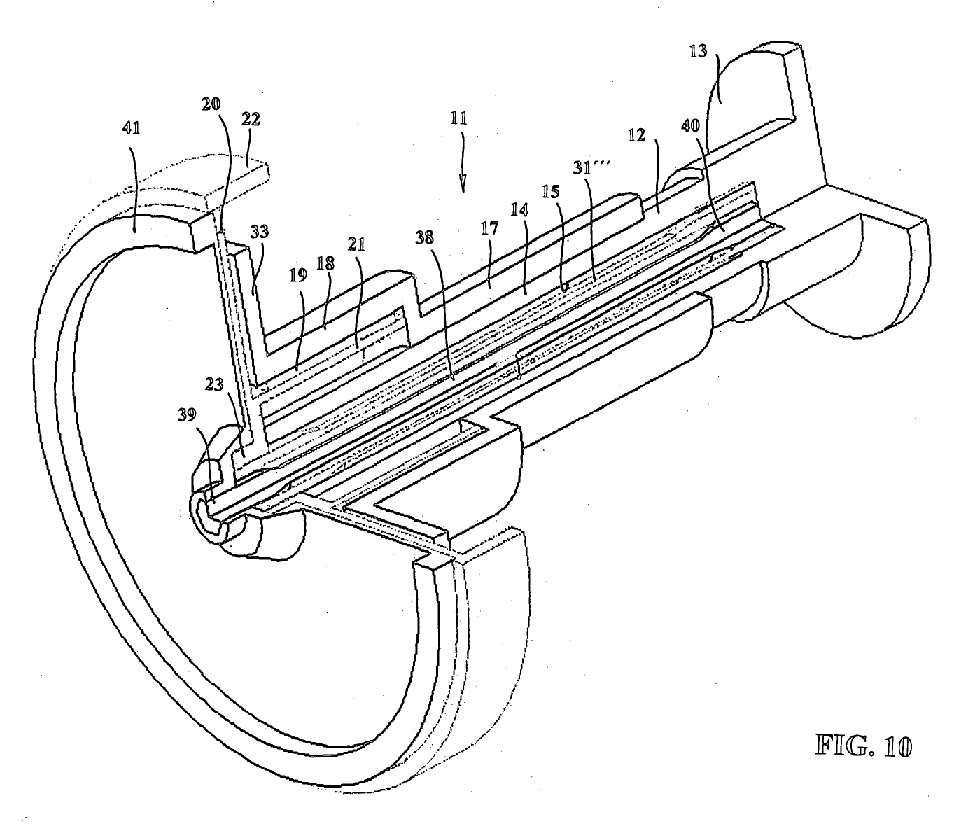

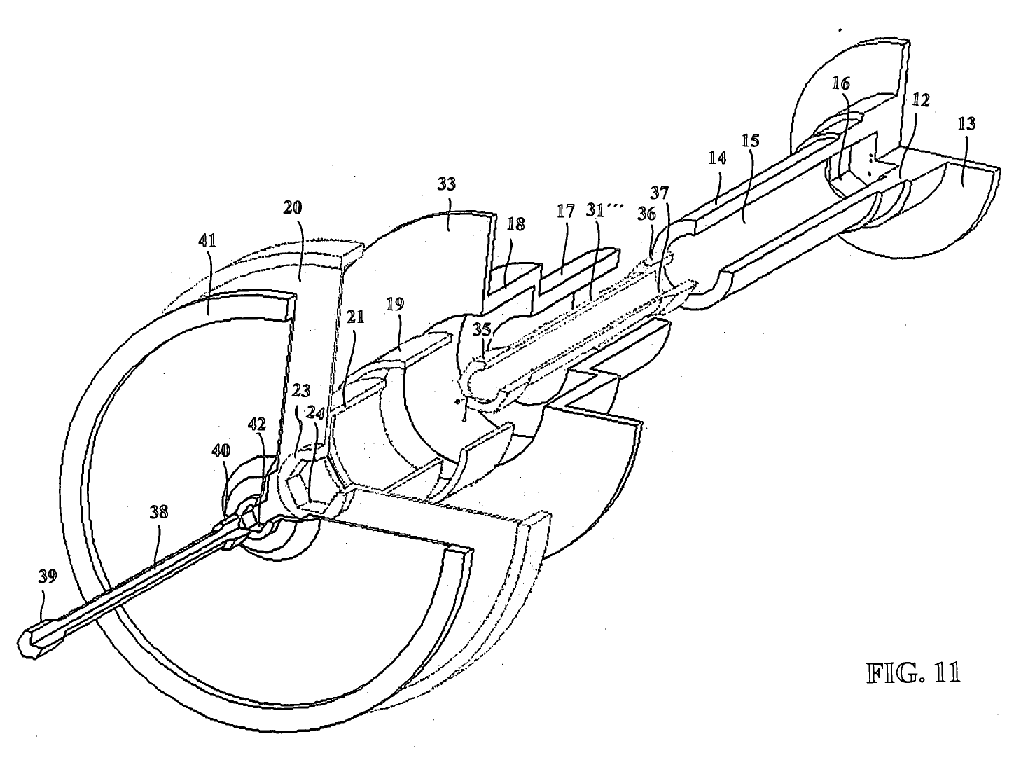

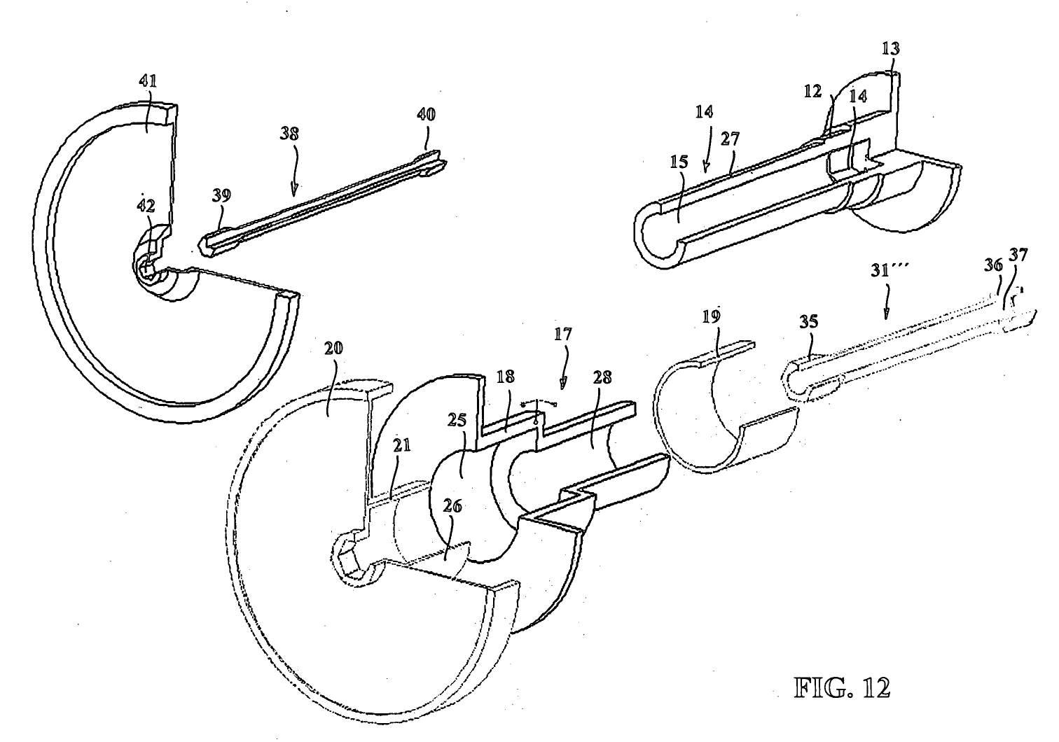

FIGS. 10, 11 and 12 show a fourth embodiment of an inventive torsion vibration damping device, according to the invention. Any details which have merely been modified to corresponding structures in FIGS. 1-5 have been given a triple index “′″”. The torsion spring 31′″ deviates from the first and the second embodiment in that it is illustrated as a solid hollow bar. The damping forces occur as a result of internal material damping during torsion. The torsion spring 31′″ comprises external hexagonal end portions, has the shape of a hexagon socket 37 at its end facing the shaft and, in the central region, is provided in the form of an internally and externally round hollow bar. Inside the hollow bar, there is positioned a bar-shaped further torsion spring 38 in the form of a solid bar comprising hexagonal end portions 39, 40. On to the front end 39 projecting from the driving disc 20 there has been placed a disc-shaped absorber mass 41 with a central hexagon socket aperture 42, whereas the rear end 40 is form-fittingly inserted into the hexagon socket 37 of the torsion spring 31′″. As can be seen, the further torsion spring 38 is not positioned in the torque flow from the driveshaft 13 to the driving disc 20 and is capable of free torsional vibrations relative to the driveshaft 13. By selecting suitable spring stiffness values and/or a suitable size of the absorber mass 41, it is possible to set the internal frequency of said absorber assembly, so that certain frequencies of the rotational vibration of the driveshaft 13 can be suppressed.

According to another embodiment, an absorber assembly can be provided which extends coaxially relative to the driveshaft 13. In this way, it is possible to combat disadvantageous internal frequencies of the driveshaft. Specifically, in connection with a torsion spring provided in the form of a hollow shaft, an absorber assembly can be provided comprises a further bar-shaped torsion spring 38 which is positioned in the torsion spring 31 and whose one end facing the shaft is connected to the driveshaft at least indirectly in rotationally fast way and whose other end carries an absorber mass 41 capable of rotational vibrations.

1. A decoupling device for a driving disc comprising a driveshaft and a torsion spring, wherein one end of the driveshaft is provided in the form of a hollow shaft, wherein the torsion spring is bar-shaped and comprises first securing means at one end of the torsion spring and is thereby secured in a rotationally fast way in the driveshaft, and second securing means at another end of the torsion spring is secured at the driving disc, and wherein a bearing sleeve, which is freely rotatably supported relative to the free end of the hollow shaft is firmly connected to the driving disc.

2. A decoupling device according to claim 1, wherein the driveshaft, further comprises a bearing sleeve at the region of the hollow shaft, which supportingly cooperates with the bearing sleeve of the driving disc.

3. A decoupling device according to claim 2, wherein a bearing portion of the bearing sleeve surrounds an inner portion of the bearing sleeve.

4. A decoupling device according to claim 2, wherein a bearing portion of the bearing sleeve rests against the inside of an outer bearing sleeve of the driving disc.

5. A decoupling device according to claim 2, further comprising bearing means, which bearing means includes a friction bearing bush between the bearing sleeve on the driveshaft and the bearing sleeve at the driving disc.

6. A decoupling device according to claim 3, further comprising bearing means, which bearing means includes a friction bearing bush between the bearing sleeve on the driveshaft and the bearing sleeve at the driving disc.

7. A decoupling device according to claims 4, further comprising bearing means, which bearing means includes a friction bearing bush between the bearing sleeve on the driveshaft and the bearing sleeve at the driving disc.

8. A decoupling device according to claim 2, wherein axial securing means are provided between the bearing sleeve and the driving disc thereby permitting free rotation.

9. A decoupling device according to claim 3, wherein axial securing means are provided between the bearing sleeve and the driving disc thereby permitting free rotation.

10. A decoupling device according to claim 4, wherein axial securing means are provided between the bearing sleeve and the driving disc thereby permitting free rotation.

11. A decoupling device according to claim 2, wherein the bearing sleeve is threaded onto a fixing portion on hollow shaft of the driveshaft.

12. A decoupling device according to claims 3, wherein the bearing sleeve is threaded onto a fixing portion on hollow shaft of the driveshaft.

13. A decoupling device according to claim 4, wherein the bearing sleeve is threaded onto a fixing portion on hollow shaft of the driveshaft.

14. A decoupling device according to claim 1, wherein the torsion spring comprises a bundle of individual bars, which bars can include hexagonal bars.

15. A decoupling device according to claim 2, wherein the torsion spring comprises a bundle of individual bars, which bars can include hexagonal bars.

16. A decoupling device according to claim 3, wherein the torsion spring comprises a bundle of individual bars, which bars can include hexagonal bars.

17. A decoupling device according to claim 4, wherein the torsion spring comprises a bundle of individual bars, which bars can include hexagonal bars.

18. A decoupling device according to claim 1, wherein the torsion spring is a solid part.

19. A decoupling device according to claim 2, wherein the torsion spring is a solid part.

20. A decoupling device according to claim 3, wherein the torsion spring is a solid part.

21. A decoupling device according to claim 4, wherein the torsion spring is a solid part.

22. A decoupling device according to claim 1, wherein the torsion spring cooperates in a rotationally fast way with form-fitting means in the driveshaft and with form-fitting means in the driving disc by axial end portions, wherein said form fitting means can include hexagon socket holes.

23. A decoupling device according to claim 2, wherein the torsion spring cooperates in a rotationally fast way with form-fitting means in the driveshaft and with form-fitting means in the driving disc by axial end portions, wherein said form fitting means can include hexagon socket holes.

24. A decoupling device according to claim 3, wherein the torsion spring cooperates in a rotationally fast way with form-fitting means in the driveshaft and with form-fitting means in the driving disc by axial end portions, wherein said form fitting means can include hexagon socket holes.

25. A decoupling device according to claim 4, wherein the torsion spring cooperates in a rotationally fast way with form-fitting means in the driveshaft and with form-fitting means in the driving disc by axial end portions, wherein said form fitting means can include hexagon socket holes.

26. A decoupling device according to claim 1, wherein the torsion spring comprises a solid bar, said solid bar comprising a central portion having a round cross-section and polygonal end portions.

27. A decoupling device according to claim 2, wherein the torsion spring comprises a solid bar, said solid bar comprising a central portion having a round cross-section and polygonal end portions.

28. A decoupling device according to claim 3, wherein the torsion spring comprises a solid bar, said solid bar comprising a central portion having a round cross-section and polygonal end portions.

29. A decoupling device according to claim 4, wherein the torsion spring comprises a solid bar, said solid bar comprising a central portion having a round cross-section and polygonal end portions.

30. A decoupling device according to claim 1, wherein the torsion spring comprises a hollow bar, which hollow bar comprises a central portion having a round cross-section and polygonal end portions.

31. A decoupling device according to claim 2, wherein the torsion spring comprises a hollow bar, which hollow bar comprises a central portion having a round cross-section and polygonal end portions.

32. A decoupling device according to claim 3, wherein the torsion spring comprises a hollow bar, which hollow bar comprises a central portion having a round cross-section and polygonal end portions.

33. A decoupling device according to claim 4, wherein the torsion spring comprises a hollow bar, which hollow bar comprises a central portion having a round cross-section and polygonal end portions.

34. A decoupling device according to claim 1, further comprising an absorber assembly which extends coaxially relative to the driveshaft.

35. A decoupling device according to claim 2, further comprising an absorber assembly which extends coaxially relative to the driveshaft.

36. A decoupling device according to claim 3, further comprising an absorber assembly which extends coaxially relative to the driveshaft.

37. A decoupling device according to claim 4, further comprising an absorber assembly which extends coaxially relative to the driveshaft.

38. A decoupling device according to claim 1, wherein the absorber assembly comprises a second bar-shaped torsion spring positioned in the torsion spring, and which second bar-shaped torsion spring has an end facing the shaft, which end is connected to the driveshaft in a rotationally fast way, and whose other end carries an absorber mass capable of rotational vibrations.

39. A decoupling device according to claim 2, wherein the absorber assembly comprises a second bar-shaped torsion spring positioned in the torsion spring, and which second bar-shaped torsion spring has an end facing the shaft, which end is connected to the driveshaft in a rotationally fast way, and whose other end carries an absorber mass capable of rotational vibrations.

40. A decoupling device according to claim 3, wherein the absorber assembly comprises a second bar-shaped torsion spring positioned in the torsion spring, and which second bar-shaped torsion spring has an end facing the shaft, which end is connected to the driveshaft in a rotationally fast way, and whose other end carries an absorber mass capable of rotational vibrations.

41. A decoupling device according to claim 4, wherein the absorber assembly comprises a second bar-shaped torsion spring positioned in the torsion spring, and which second bar-shaped torsion spring has an end facing the shaft, which end is connected to the driveshaft in a rotationally fast way, and whose other end carries an absorber mass capable of rotational vibrations.
